(19) United States
(12) Patent Application Publication
(10) Pub. No.: US 2018/0359660 A1
(43) Pub. Date: Dec. 13, 2018

(54) SYSTEM AND METHOD FOR MAINTAINING A NETWORK CONNECTION

(71) Applicant: QUALCOMM Incorporated, San Diego, CA (US)

(72) Inventors: Srinivasa Ragimakalahally KONAPPA, Bangalore (IN); Prashanth MOHAN, Hyderabad (IN); Vinaya Kumara T.V., Tumkur (IN); Radvajesh MUNIBYRAIAH, Bangalore (IN)

(21) Appl. No.: 15/619,392

(22) Filed: Jun. 9, 2017

(51) Int. Cl. H04W 36/00; H04W 36/08

(52) U.S. Cl. CPC H04W 36/0011; H04W 36/30; H04W 36/08

(57) ABSTRACT

Allocation failures may occur on a network during handovers. Therefore, a user equipment (UE) may include a configurable timer that is configured to begin once an allocation or grant is revoked or a quality-of-service (QoS) condition is unsatisfied. A UE may be configured to wait for an allocation or grant or may be configured to elicit an allocation or grant. During a network connection, a UE may determine that the allocation or grant is unreceived before expiration of the configurable timer. Based on the determination that the allocation or grant is unreceived before expiration of the configurable timer, the UE may transit a session initiation protocol (SIP) re-invite message in order to allow a network to bring up dedicated bearers for the network connection.

### BACKGROUND

### Field

The present disclosure relates generally to communication systems, and more particularly, to a user equipment configured to maintain a network connection.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first user equipment (UE). The apparatus may attempt to move a network connection in a handover from a first network node to a second network node by determining whether a quality of service (QoS) grant associated with the network connection is unreceived before expiration of a first timer. The network connection may be associated with the apparatus and a second UE. The apparatus may transmit a first session initiation protocol (SIP) re-invite message based on the determination that the QoS grant is unreceived before the expiration of the first timer. The apparatus may determine that the QoS grant is unreceived before expiration of a second timer, and the second timer may have a second duration less than a first duration of the first timer. The apparatus may transmit a second SIP re-invite message to the second UE based on the determination that the QoS grant is unreceived before the expiration of the second timer. The second SIP re-invite message may include at least one session description protocol (SDP) parameter indicating that the apparatus is in an inactive mode to avoid a timeout associated with the second UE. The apparatus may transmit a SIP message to the second UE, and the SIP message may indicate that the apparatus is requesting the QoS grant associated with the network connection. The SIP message may be a SIP INFO message. The apparatus may transmit a resource allocation request after the transmission of the SIP message. In an aspect, the SIP message further includes a third duration, associated with a third timer, for which the second UE is to wait before termination of the network connection associated with the apparatus and the second UE. The apparatus may maintain the network connection via a default bearer until expiration of the third timer or until the QoS grant associated with the network connection is received by the apparatus. The apparatus may determine that the QoS grant is unreceived before expiration of the third timer. The apparatus may retransmit the resource allocation request based on the determination that the QoS grant is unreceived after the expiration of the third timer. The apparatus may restart the third timer. The apparatus may determine that the QoS grant is unreceived after a predetermined number of retransmissions of the resource allocation request. The apparatus may restart the first timer to wait for the QoS grant associated with the network connection. In an aspect, the predetermined number of retransmissions is four (4), and the resource allocation request is not retransmitted after a fifth expiration of the third timer. The apparatus may receive the QoS grant associated with the network connection. The apparatus may maintain the network connection based on the received QoS grant associated with the network connection. In an aspect, the second UE is a terminating device for the network connection. In an aspect, the first network node is one of a first eNB or a first wireless local area network (WLAN) access point (AP), and the second network node is one of a second eNB or a second WLAN AP.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating an example of a base station and user equipment (UE) in an access network.

FIG. 4 is a diagram of a wireless communications system.

FIG. 5 is a call flow diagram of a wireless communications system.

FIGS. 6A and 6B are a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

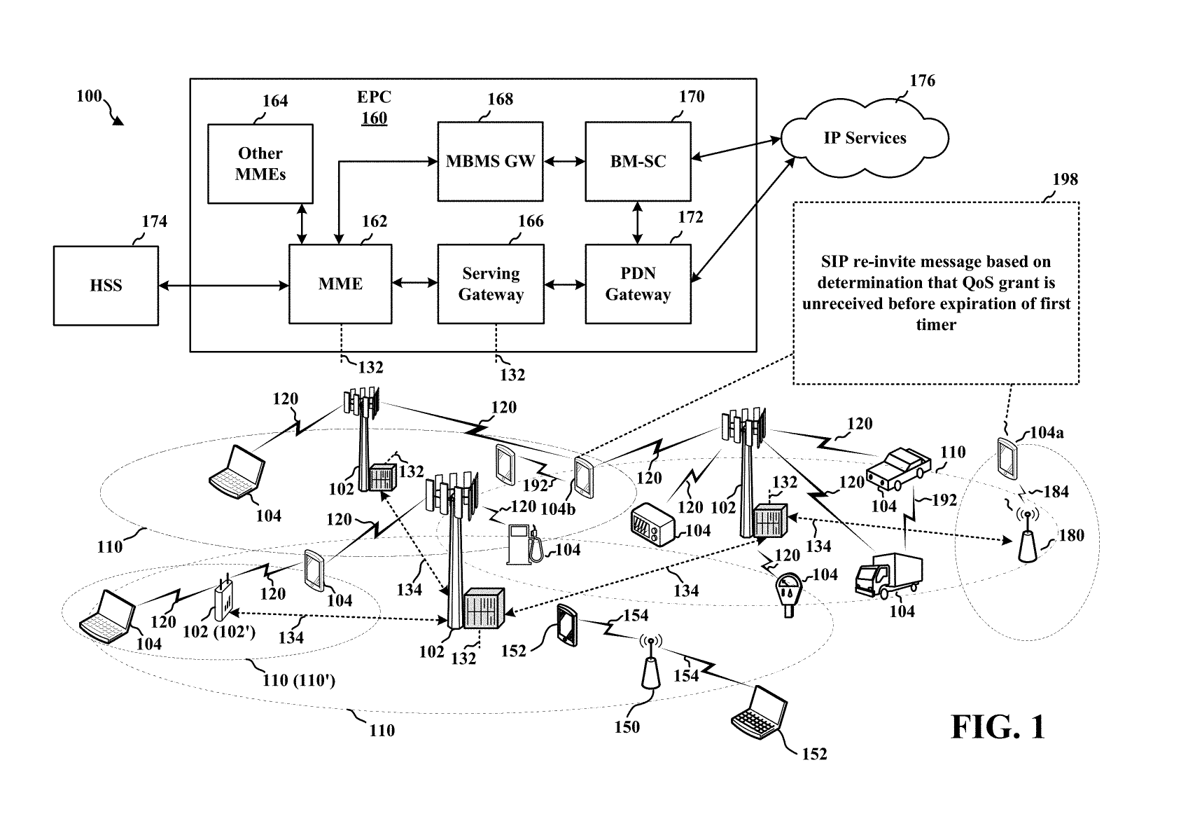

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104a may attempt to move a network connection in a handover from a first network node to a second network node by determining whether a quality of service (QoS) grant associated with the network connection is unreceived before expiration of a first timer. The network connection may be associated with the UE 104a and a second UE 104b. The UE 104a may transmit a first session initiation protocol (SIP) re-invite message 198 based on the determination that the QoS grant is unreceived before the expiration of the first timer. The UE 104a may determine that the QoS grant is unreceived before expiration of a second timer, and the second timer may have a second duration less than a first duration of the first timer. The UE 104a may transmit a second SIP re-invite message to the second UE 104b based on the determination that the QoS grant is unreceived before the expiration of the second timer. The second SIP re-invite message may include at least one session description protocol (SDP) parameter indicating that the UE 104a is in an inactive mode to avoid a timeout associated with the second UE 104b. The UE 104a may transmit a SIP message to the second UE 104b, and the SIP message may indicate that the UE 104a is requesting the QoS grant associated with the network connection. The SIP message may be a SIP INFO message. The UE 104a may transmit a resource allocation request after the transmission of the SIP message (e.g., the UE 104a may transmit the resource allocation request to the MME 162). In an aspect, the SIP message further includes a third duration, associated with a third timer. The third duration may indicate to the second UE 104b how long to wait before terminating the network connection associated with the UE 104a and the second UE 104b. The UE 104a may maintain the network connection via a default bearer until expiration of the third timer or until the QoS grant associated with the network connection is received by the UE 104a. The UE 104a may determine that the QoS grant is unreceived before expiration of the third timer. The UE 104a may retransmit the resource allocation request based on the determination that the QoS grant is unreceived after the expiration of the third timer. The UE 104a may restart the third timer. The UE 104a may determine that the QoS grant is unreceived after a predetermined number of retransmissions of the resource allocation request. The UE 104a may restart the first timer to wait for the QoS grant associated with the network connection. In an aspect, the predetermined number of retransmissions is four (4), and the resource allocation request is not retransmitted after a fifth expiration of the third timer. The UE 104a may receive the QoS grant associated with the network connection, for example, during a duration of the first timer, the second timer, and/or the third timer. The UE 104a may maintain the network connection based on the received QoS grant associated with the network connection. In an aspect, the second UE 104b is a terminating device for the network connection. In an aspect, the first network node is one of a first eNB (e.g., base station 102) or a first wireless local area network (WLAN) AP (e.g., AP 150), and the second network node is one of a second eNB (e.g., base station 102) or a second WLAN AP (e.g., AP 150).

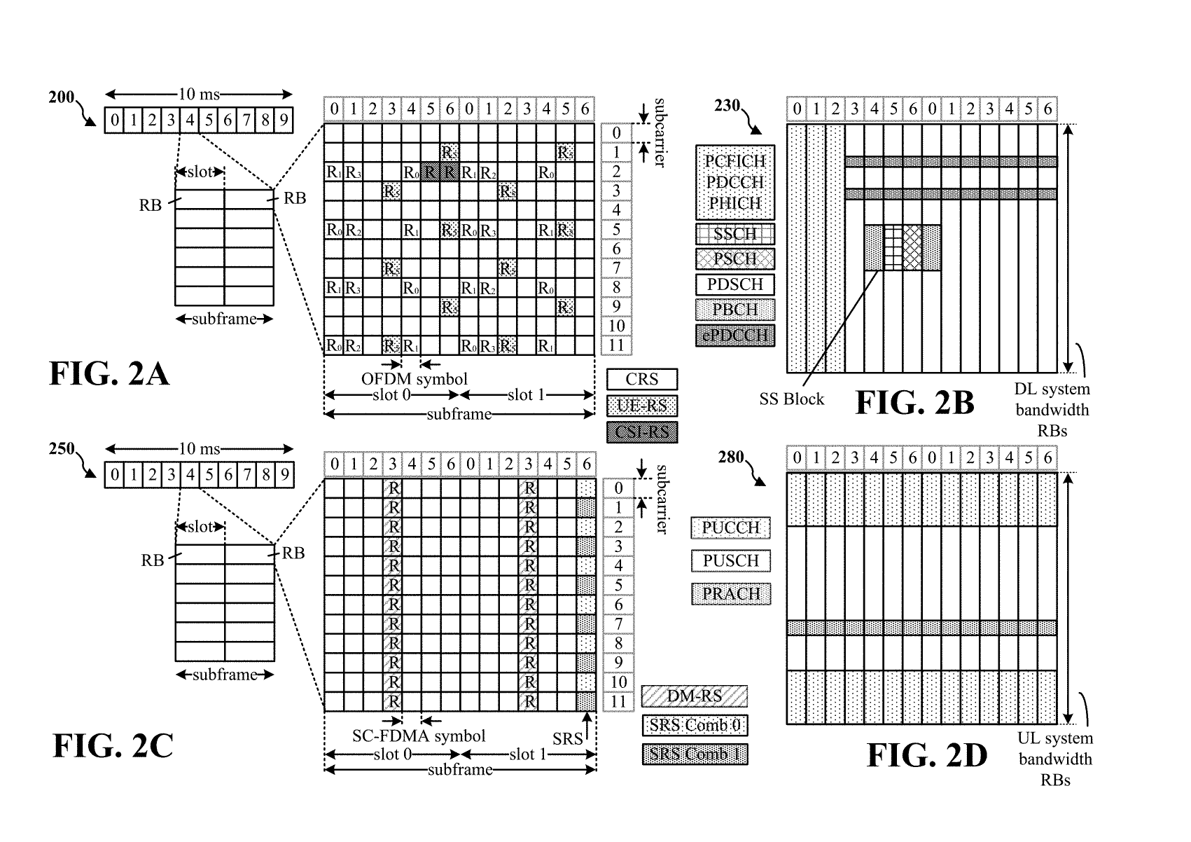

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB may contain 12 consecutive subcarriers in the frequency domain and 7 consecutive symbols (for DL, OFDM symbols; for UL, SC-FDMA symbols) in the time domain, for a total of 84 REs. For an extended cyclic prefix, an RB may contain 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE 104 to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

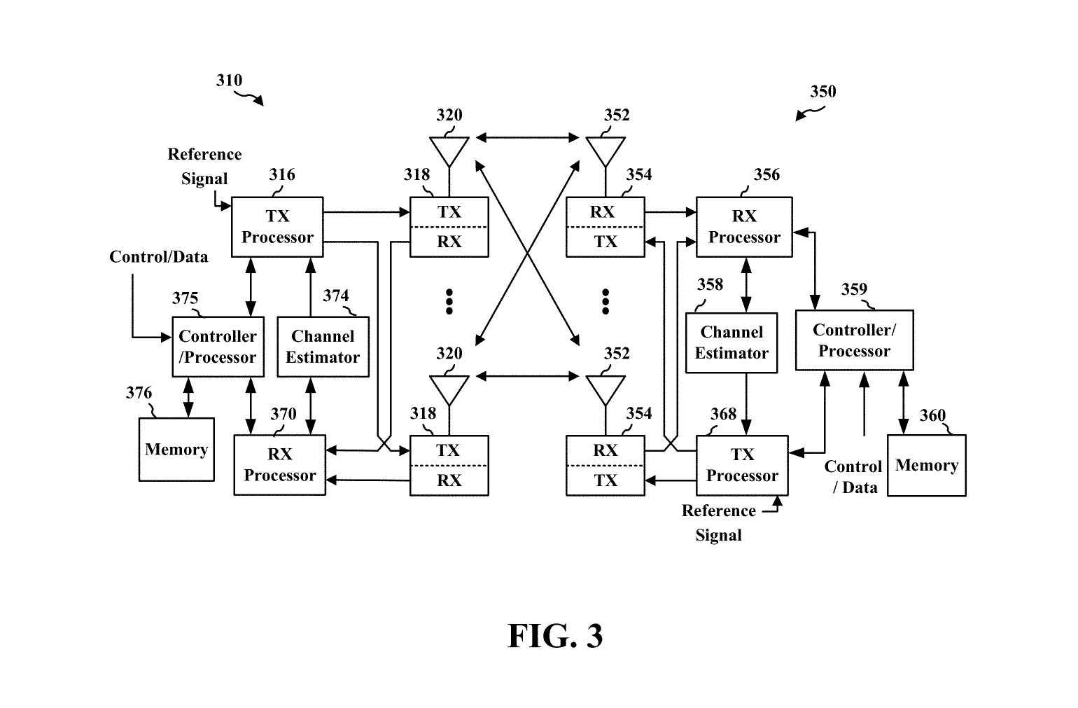

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

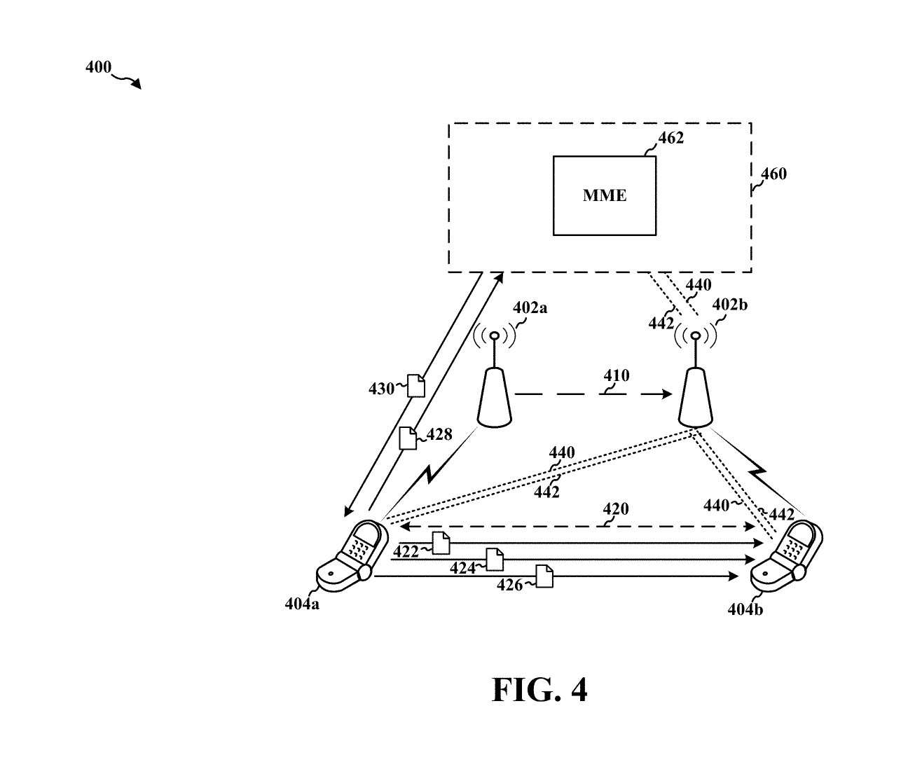

FIG. 4 is a diagram of a wireless communications system 400. The wireless communications system 400 may include at least a first UE 404a, a second UE 404b, an MME 462, a first network node 402a, and a second network node 402b. In an aspect, the MME 462 is included in a core network 460 (e.g., the MME 462 is a component of the EPC). In an aspect, each of the first network node 402a and/or the second network node 402b may be a base station, such as an eNB or gNB, or may be an AP, such as a WLAN AP (e.g., industrial WLAN (IWLAN) AP).

In various aspects, the first and second UEs 404a-b may be capable of IMS services. For example, the first and second UEs 404a-b may be capable of IMS voice-over-LTE (VOLTE)/video-telephony (VT) communication. Various network operators may provide IMS capability in respective networks, and IMS VOLTE/VT communication may be utilized by such network operators rather than legacy circuit-switched (CS) communication (e.g., voice calls). In aspects, network operators may provide dedicated bearers (e.g., QCI-1, QCI-2, etc.) for audio (e.g., QCI-1) and video (e.g., QCI-2) communication. For various IMS features, a network may provide a QoS grant, which may include allocated resources associated with a dedicated bearer for an IMS session (e.g., VOLTE/VT communication). A bearer may include a path over which traffic (e.g., IP traffic) flows when passing through a network (e.g., a path between a UE 404 and the MME 462).

Various IMS features (e.g., VOLTE/VT communication) may be independent of a RAT on which such IMS features operate. During active IMS communication (e.g., VOLTE/VT), IMS PDN handover may occur, for example, inter-eNB handover and/or inter-RAT handover. However, QoS grant failures on a network during handovers (e.g., inter-eNB handover/WLAN to LTE handover, etc.) also may occur, including during call establishment and during a communication session. Therefore, an IMS-capable UE (e.g., the first and second UEs 404a-b) may include a configurable timer T_{WaitForQoSReGrant} that is configured to begin once a QoS grant is revoked or a QoS condition is unsatisfied, e.g., the T_{WaitForQoSReGrant} timer may begin configured to begin when a UE is not allocated dedicated bearer(s) for a network connection. On expiry of the T_{WaitForQoSReGrant} timer, a UE may be configured to end a network connection (e.g., communication session)—the assumption being that the network is able to restore the QoS grant before expiry of the T_{WaitForQosReGrant} timer, but after a delay period (e.g., a delay associated with an MME tracing a target eNB and granting the QoS, a delay due to network congestion, a delay due to revocation of a QoS grant, etc.).

In some scenarios, the current T_{WaitForQoSReGrant} timer duration may be insufficient for the network to restore a QoS grant, which may cause failure of establishment of a communication session, failure of an on-going communication session, and the like. For example, a UE configured with the current T_{WaitForQoSReGrant} timer may not receive a QoS grant to establish (or reestablish) dedicated bearer(s) for a communication session before expiration of the T_{WaitForQoSReGrant} timer, which may cause the UE to prematurely terminate the communication session. Therefore, IMS-capable UEs may benefit from one or more operations that may extend the duration for which an IMS-capable UE waits before terminating a network connection. For example, the IMS-capable UE may elicit a QoS grant (e.g., after revocation), maintain an on-going network connection (e.g., after revocation), and so forth.

At the terminating side, a UE (e.g., the second UE 404b), may be configured with an real-time transport protocol (RTP)/RTP control protocol (RTCP) timer, which may have a duration of twenty (20) seconds. The RTP/RTCP timer may prevent the terminating UE from unnecessarily waiting for additional data when a network connection has ended due to, e.g., due to QoS failure. In an aspect, the T_{WaitForQoSReGrant} timer at the originating side (e.g., the first UE 404a) may have a duration that is the same or similar to the duration of the RTP/RTCP timer at the terminating side (e.g., the second UE 404b).

In various aspects, the first UE 404a and the second UE 404b may establish a network connection 420, for example, in association with a voice or video call (e.g., VOLTE/VT call) or some other IMS service. From the perspective of the first UE 404a, the second UE 404b may be a terminating device because the network connection terminates at the second UE 404b (e.g., the second UE 404b may be used by a far-end user of a call).

The network connection 420 may first operate through the first network node 402a (e.g., an eNB, an AP, etc.), which may be associated with a first RAT. The first UE 404a may be handed over from the first network node 402a to the second network node 402b (e.g., another eNB, another AP, etc.), which may be associated with a second RAT (in some aspects, the first and second RATs may be a same RAT). Thus, the first UE 404a may attempt to move the network connection 420 in the handover 410 from the first network node 402a to the second network node 402b. In connection therewith, the first UE 404a may require a QoS grant 430, for example, in order to determine resource allocation and dedicated bearer(s) 440 assigned when the network connection 420 is handed over. However, a QoS failure may occur in association with the handover.

The first UE 404a may attempt to move the network connection 420 involved in the handover 410 from the first network node 402a to the second network node 402b by determining whether a QoS grant 430 associated with the network connection 420 is unreceived before expiration of a first timer having a first duration. In aspects, the first timer may be the T_{WaitForQoSReGrant} timer. In various aspects, the first timer may be configured to have a first duration of twenty (20) seconds. By waiting for the first duration of the first timer, the first UE 404a may allow the network to provide a QoS grant 430, which may include dedicated bearer(s). However, the first UE 404a may determine that the first timer expires before the QoS grant 430 is received.

Based on the determination that the QoS grant 430 is unreceived before expiration of the first timer, the first UE 404a may transmit a first SIP re-invite message 422 to the second UE 404b. For example, the first UE 404a may generate the first SIP re-invite message 422. In an aspect, the first UE 404a may determine codec information associated with the network connection 420, which may have already been negotiated for the network connection 420, and the first UE 404a may include the determined codec information in the first SIP re-invite message 422. The first UE 404a may transmit the first SIP re-invite message 422 in order to allow the network additional time to allocate dedicated bearer(s). Thus, the first SIP re-invite message 422 may cause a session refresh.

In various aspects, the first UE 404a may further be configured with a second timer. The second timer may have a second duration that is shorter than the first duration of the first timer. For example, the first timer (e.g., T_{WaitForQoSReGrant} timer) may have a first duration of twenty (20) seconds, whereas the second timer may have a second duration of fifteen (15) seconds. The first UE 404a may begin the second timer contemporaneously with the first timer, after the first timer expires, or at another time (e.g., based on an event). The first UE 404a may begin the second timer in order to allow the network to allocate the dedicated bearer(s) for the network connection 420. For example, the first UE 404a may begin the second timer after expiration of the first timer when the QoS grant 430 is unreceived.

The first UE 404a may determine that the QoS grant 430 is unreceived before expiration of the second timer. Based on the determination that the QoS grant 430 is unreceived before expiration of the second timer, the first UE 404a may transmit a second SIP re-invite message 424. The second SIP re-invite message 424 may include at least one SDP parameter that indicates that the first UE is in an inactive mode, and the at least one SDP parameter may avoid timeout of the RTP/RTCP timer at the second UE 404b. In one aspect, the SDP parameter may include a media description (e.g., video m-line) that indicates the first UE 404a is in the inactive mode, such as when the network connection 420 includes an on-going video call. For example, the first UE 404a may generate the second SIP re-invite message 424, and may generate the second SIP re-invite message 424 to include the at least one SDP parameter indicating that the first UE 404a is in an inactive mode (e.g., the first UE 404a may enter the inactive mode when waiting for the QoS grant 430). In aspects in which the second timer has a second duration shorter than a first duration of the first timer and/or in which the second timer expires before the first timer expires, the first UE 404a may send the second SIP re-invite message 424 before the first timer expires, before the first UE 404a sends the first SIP re-invite message 422, before both the first timer expires and the first UE 404a sends the first SIP re-invite message 422, and/or at any other suitable time.

In aspects, the first UE 404a may transmit, to the second UE 404b, a SIP message 426. The SIP message 426 may be a SIP INFO message, such as an in-dialog SIP INFO message. The SIP message 426 may indicate that the first UE 404a is requesting the QoS grant 430 associated with the network connection 420. For example, the first UE 404a may generate the SIP message 426, which may indicate that the first UE 404a is requesting the QoS grant 430 associated with the network connection 420.

The first UE 404a may be configured with a third timer having a third duration (e.g., eight (8) seconds). The third timer may be associated with a request for bearer resource allocation. For example, the third timer may be associated with a bearer resource allocation request procedure, which may be defined according to one or more standards for wireless communication (e.g., 3GPP TS 24.301 or some other technical standard). In an aspect, the third timer may be a T3480 timer, which may be defined according to one or more standards for wireless communication (e.g., 3GPP TS 24.301 or another technical standard).

In one aspect, the SIP message 426 may include the third duration associated with the third timer, e.g., in order to indicate a duration for which the second UE 404b is to wait before termination of the network connection 420 by the second UE 404b. For example, the first UE 404a may generate the SIP message 426, and may include therein the third duration associated with the third timer.

In aspects, the first UE 404a may transmit a resource allocation request 428. The first UE 404a may transmit the resource allocation request 428 to the MME 462. The resource allocation request 428 may be a bearer resource allocation request message (e.g., a bearer resource allocation request as defined in 3GPP TS 24.301 or another technical standard). For example, the first UE 404a may generate the resource allocation request 428 to request that the MME 462 allocate the dedicated bearer(s) for the network connection 420. In an aspect, the first UE 404a may transmit the resource allocation request 428 after the first UE 404a transmits the SIP message 426. In an aspect, the first UE 404a may transmit the resource allocation request 428 after expiration of the first timer.

According to aspects, the first UE 404a may begin the third timer. For example, the first UE 404a may begin the third timer based on transmission of the resource allocation request 428. The first UE 404a may determine that the QoS grant 430 is unreceived after a first expiration of the third timer.

According to an aspect, the first UE 404a may maintain the network connection via a default bearer 442, for example, based on the determination that the QoS grant 430 is unreceived after the first expiration of the third timer. That is, the first UE 404a may maintain the network connection 420 via the default bearer 442 because the first UE 404a lacks dedicated bearer(s) 440 allocated by the QoS grant 430 for the network connection 420. In another aspect, the first UE 404a may maintain the network connection 420 via the default bearer 442 based on the determination that the QoS grant 430 is unreceived before expiration of the first timer or based on another determination/event (e.g., based on transmission of the resource allocation request 428). Thus, the first UE 404a may prevent the ending and/or failure of the network connection 420 even though the dedicated bearer(s) 440 are unestablished for the network connection 420 by utilizing the default bearer 442.

The default bearer 442 may be a bearer associated with an IP address and may provide a best effort service. The default bearer 442 may be created when the first UE 404a initially attaches to the network, such as the network associated with the second network node 402b. However, the default bearer 442 may not guarantee the same or similar QoS as the dedicated bearer(s) 440, particularly with respect to VOLTE/VT communication. The dedicated bearer(s) 440 may provide a dedicated tunnel for specific traffic of the network connection 420 (e.g., VOLTE/VT) and, therefore, may meet one or more QoS conditions (e.g., QoS conditions required for VOLTE/VT) associated with the specific traffic (e.g., VOLTE/VT). However, the dedicated bearer(s) 440 may be allocated via the (unreceived) QoS grant 430.

Based on the determination that the QoS grant 430 is unreceived before expiration of the third timer, the first UE 404a may retransmit the resource allocation request 428. After the retransmission of the resource allocation request 428, the first UE 404a may restart the third timer. The first UE 404a may be configured to retransmit the resource allocation request 428 after expiration of the restarted third timer. In various aspects, the first UE 404a may be configured to restart the third timer and retransmit the resource allocation request 428 a plurality of times. In one aspect, the first UE 404a may determine that the QoS grant 430 is still unreceived after a predetermined number of retransmissions of the resource allocation request 428. By way of example, the predetermined number of retransmissions of the resource allocation request 428 may be four (4) and, therefore, the first UE 404a would refrain from retransmission of the resource allocation request 428 after a fifth expiration of the third timer. After the predetermined number of retransmissions of the resource allocation request 428 has occurred and the restarted third timer expires after the final retransmission of the resource allocation request 428 (e.g., the fifth expiration of the third timer) without reception of the QoS grant 430, the first UE 404a may release a procedure transaction identity (PTI) allocated to the first UE 404a by the MME 462 in association with the bearer resource activation procedure.

After the final expiration of the third timer (e.g., the fifth expiration of the third timer), the first UE 404a may determine that the QoS grant 430 is still unreceived. Based on the determination that the QoS grant 430 is still unreceived after the final expiration of the third timer, the first UE 404a may restart the first timer in order to continue to wait for the QoS grant 430 associated with the network connection 420. The first UE 404a may then repeat one or more of the aforementioned operations. For example, the first UE 404a may again transmit a SIP re-invite message (similar to the first SIP re-invite message 422) after a second expiration of the first timer. The first UE 404a may also determine that the QoS grant 430 is unreceived before a second expiration of the second timer, and transmit another SIP re-invite message (e.g., similar to the second SIP re-invite message 424) based on that determination. And so forth until either a QoS grant 430 is received or the network connection is ended (e.g., the first UE 404a ends a VOLTE/VT call). During this time, the first UE 404a may continue to maintain the network connection 420 via the default bearer 442.

In various aspects, the first UE 404a may receive the QoS grant 430, for example, from the MME 462. The received QoS grant 430 may allocate the dedicated bearer(s) 440. Thus, the first UE 404a may determine allocation of the dedicated bearer(s) 440 and/or one or more resources for the network connection 420 based on the received QoS grant 430 (e.g., the QoS grant 430 may indicate the dedicated bearer(s) 440 and/or allocate resources for the network connection 420). Based on the QoS grant 430, the first UE 404a may maintain the network connection 420 via the dedicated bearer(s) 440. For example, if the first UE 404a is maintaining the network connection 420 via the default bearer 442, the first UE 404a may move the network connection 420 to the dedicated bearer(s) 440. If the network connection 420 is not maintained via the default bearer 442 (e.g., the network connection 420 is paused), the first UE 404a may establish the network connection 420 via the dedicated bearer(s) 440.

In various aspects, the first UE 404a may refrain from performing one or more of the aforementioned operations when the QoS grant 430 is received. That is, when the first UE 404a receives the QoS grant 430, the first UE 404a may transition the network connection 420 to the dedicated bearer(s) 440 and continue the network connection 420 thereon until the network connection 420 ends (e.g., a call utilizing the network connection 420 ends), until a QoS revocation (e.g., dedicated bearer(s) are revoked), etc. Consequently, the first UE 404a may refrain from transmitting SIP re-invite messages, SIP messages, resource allocation requests, and so forth because the first UE 404a may determine that the QoS grant 430 is received (e.g., before expiration of the first timer, before expiration of the second timer, before expiration of the third timer, etc.).

While the present disclosure describes operations for maintaining a network connection during handover, one of ordinary skill will appreciate that one or more operations described herein may be implemented by the first UE 404a during initiation or establishment of a network connection with the second UE 404b. For example, the first UE 404a may transmit a resource allocation request 428 at initiation of a network connection (e.g., call establishment) and may begin the third timer (e.g., the T3480 timer). At expiry of the third timer, the first UE 404a may cause establishment of the network connection 420 via the default bearer 442 and perform one or more operations described in the present disclosure in order to wait for and/or elicit a QoS grant 430 for the network connection 420, which may allocate the dedicated bearer(s) 440 via which the network connection 420 may be maintained after establishment of the network connection 420 via the default bearer 442.

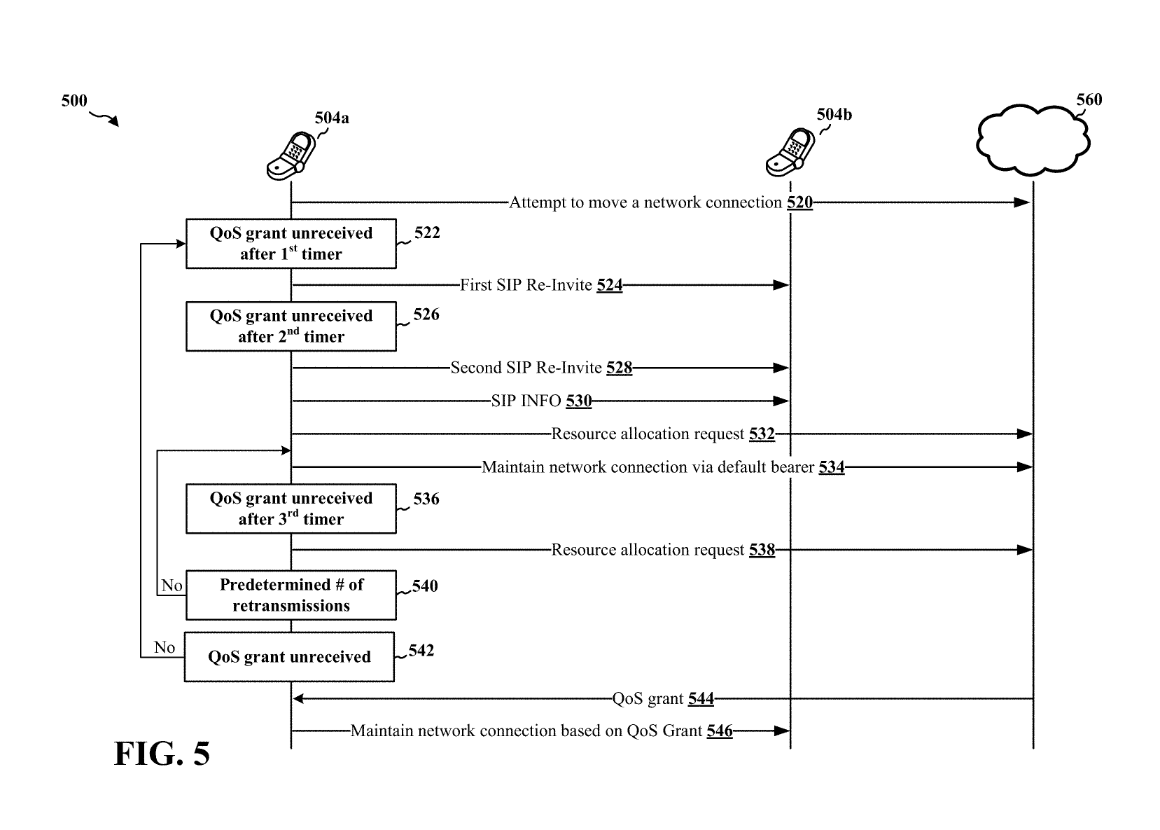

FIG. 5 is a call flow diagram illustrating operations performed in a wireless communications system 500. In an aspect, FIG. 5 may illustrate the flow of operations described with respect to FIG. 4. Accordingly, the first UE 504a may be an aspect of the first UE 404a, the second UE 504b may be an aspect of the second UE 404b, and the network 560 may include the core network 460 including the MME 462.

Beginning at operation 520, the first UE 504a may attempt to move a network connection associated with the second UE 504b. For example, the first UE 504a may attempt to move the network connection in a handover from a first network node to a second network node, which may be an inter-base station (e.g., inter-eNB) handover, a WLAN to cellular handover (e.g., IWLAN to LTE handover), or another handover.

At operation 522, the first UE 504a may determine that a QoS grant is unreceived before expiration of a first timer (e.g., a T_{WaitForQoSReGrant} timer). For example, the first UE 504a may determine that a QoS grant is unreceived for the network 560 associated with the second network node to which the first UE 504a is handed over.

At operation 524, the first UE 504a may transmit a first SIP re-invite message based on the determination that the QoS grant is unreceived before expiration of the first timer. For example, the first UE 504a may generate a SIP re-invite message, which may include codec information negotiated for the network connection associated with the first UE 504a and the second UE 504b, in order to allow the network 560 to allocate dedicated bearer(s) for the network connection (e.g., a session refresh). The first UE 504a may transmit the first SIP re-invite message to the second UE 504b.

At operation 526, the first UE 504a may determine that the QoS grant is unreceived before expiration of a second timer. In an aspect, the second timer may have a second duration shorter than a first duration of the first timer. In an aspect, the second timer may expire before or after the first timer, depending on when the first UE 504a begins the second timer with respect to the first timer.

At operation 528, the first UE 504a may transmit, to the second UE 504b, a second SIP re-invite message based on the determination that the QoS grant is unreceived before expiration of the second timer. For example, the first UE 504a may generate a second SIP re-invite message to include at least one SDP that indicates the first UE 504a is in an inactive mode, which may prevent a timeout associated with the second UE 504b. The at least one SDP parameter may include a video m-line set to indicate inactive (e.g., to avoid RTP/RTCP timeout at the second UE 504b). In aspects in which the second timer has a second duration shorter than a first duration of the first timer (e.g., as discussed with reference to operation 526) and/or in which the second timer expires before the first timer expires, the first UE 504a may send the second SIP re-invite message before the first timer expires, before the first UE 504a sends the first SIP re-invite message at operation 524, before both the first timer expires and the first UE 504a sends the first SIP re-invite message at operation 524, and/or at any other suitable time.

At operation 530, the first UE 504a may transmit, to the second UE 504b, a SIP INFO message that indicates to the second UE 504b that the first UE 504a is requesting the QoS grant associated with the network connection between the first UE 504a and the second UE 504b. For example, the first UE 504a may generate a SIP INFO message to indicate that the process of dedicated bearer(s) allocation is pending. In one aspect, the first UE 504a may indicate, in the SIP INFO message, a duration for which the second UE 504b is to wait before termination of the network connection at the second UE 504b. The indicated duration may be associated with a third timer at the first UE 504a, such as a T3480 timer associated with a bearer resource allocation procedure to be performed by the first UE 504a.

At operation 532, the first UE 504a may transmit, to the network 560, a resource allocation request. The first UE 504a may transmit the resource allocation request after transmission of the SIP INFO message. For example, the first UE 504a may generate a resource allocation request (e.g., a bearer resource allocation request message) and transmit the generated resource allocation request to an MME associated with the network 560.

At operation 534, the first UE 504a may maintain the network connection via a default bearer. The first UE 504a may maintain the network connection via the default bearer until a response to the resource allocation request is received. The first UE 504a may maintain the network connection via the default bearer after expiration of the first timer, after expiration of the third timer, or at any other point. The first UE 504a may maintain the network connection via the default bearer until the QoS grant is received or until the network connection is ended (e.g., a user of the first UE 504a or a user of the second UE 504b ends a call).

At operation 536, the first UE 504a may determine that the QoS grant is unreceived before expiration of the third timer. The third timer may be a T3480 timer associated with a bearer allocation request procedure. For example, the first UE 504a may begin the third timer after transmission of the resource allocation request, and the first UE 504a may await a response to the resource allocation request during the duration of the third timer.

At operation 538, the first UE 504a may retransmit, to the network 560, the resource allocation request based on the determination that the QoS grant is unreceived before expiration of the third timer. The first UE 504a may retransmit the resource allocation message to an MME associated with the network 560. The first UE 504a may restart the third timer in association with the retransmission of the resource allocation request.

At operation 540, the first UE 504a may determine that the QoS grant is unreceived after a predetermined number of retransmissions of the resource allocation request or a predetermined number of expirations of the third timer. For example, the first UE 504a may retransmit the resource allocation message four (4) times, as described at operation 538. Returning to operation 536, the first UE 504a may determine that the QoS grant is unreceived before expiration of the third timer, which the first UE 504a restarts in association with each retransmission. Once the predetermined number of retransmissions (e.g., four (4)) and/or the predetermined number of expirations of third timer (e.g., five (5)) has occurred, the first UE 504a may abort the bearer resource allocation request procedure and release the PTI allocated for the bearer resource allocation request procedure. During the bearer resource allocation request procedure, the first UE 504a may maintain the network connection via the default bearer.

At operation 542, the first UE 504a may determine that the QoS grant is unreceived. If the first UE 504a determines that the QoS grant is unreceived, the first UE 504a may restart the first timer to wait for the QoS grant. In an aspect, the first UE 504a may perform one or more of the aforementioned operations after restarting and/or after expiration of the first timer.

At operation 544, the first UE 504a may receive the QoS grant associated with the network connection. The first UE 504a may determine dedicated bearer(s) and/or resource allocation information associated with the network connection based on the QoS grant.

At operation 546, the first UE 504a may maintain the network connection based on the QoS grant. For example, the first UE 504a may establish or move the network connection to the dedicated bearer(s) determined from the QoS grant.

If the first UE 504a receives the QoS grant at any point in time, the first UE 504a may maintain the network connection based on the QoS grant and refrain from performing operations designed to elicit a QoS grant and/or allow the network 560 to provide a QoS grant (i.e., because the QoS grant is already provided). The first UE 504a may maintain the network connection via the dedicated bearer(s) until the network connection ends (e.g., a call ends) or until the QoS grant is revoked and the first UE 504a again attempts to receive a QoS grant.

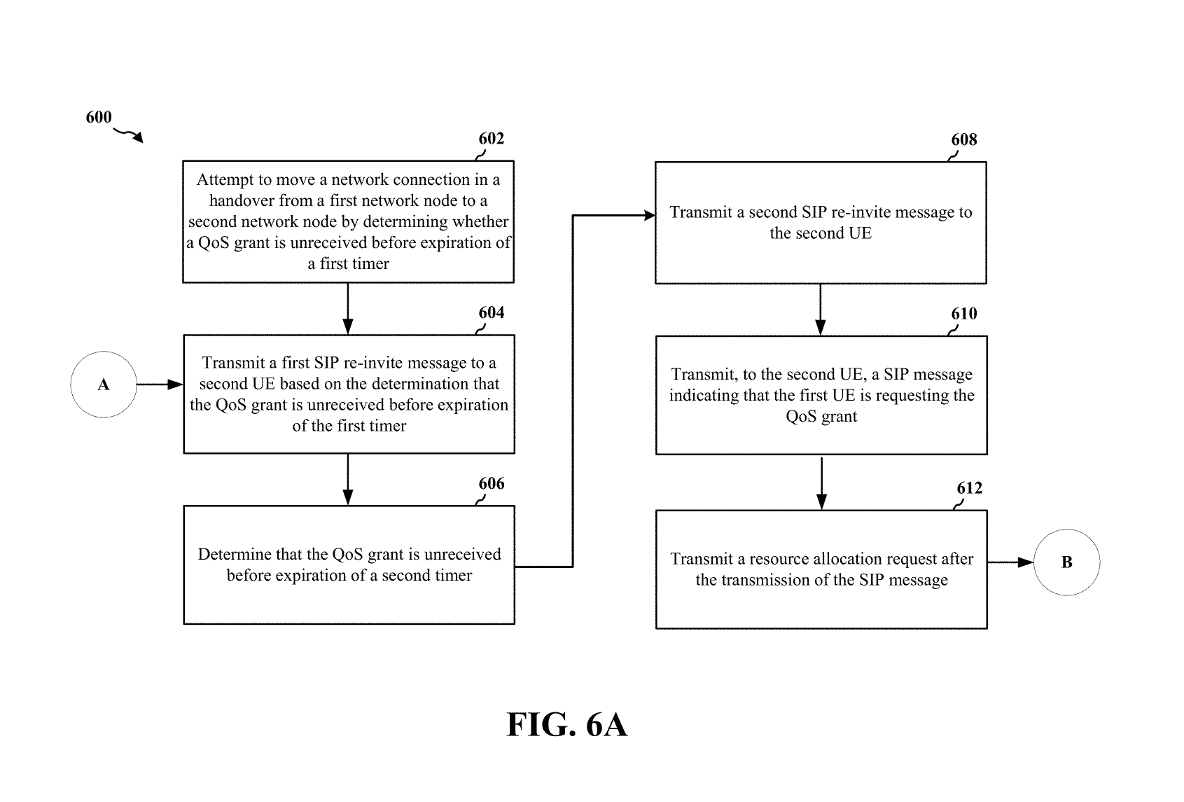

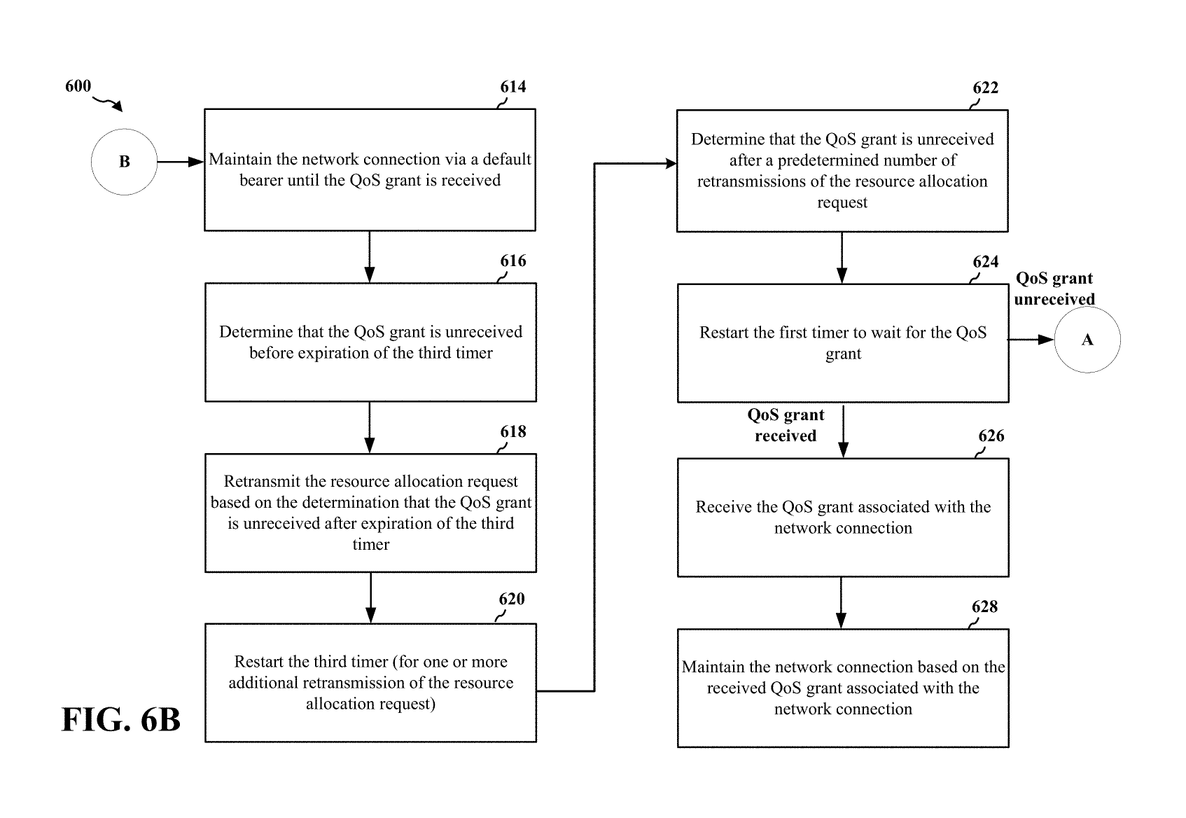

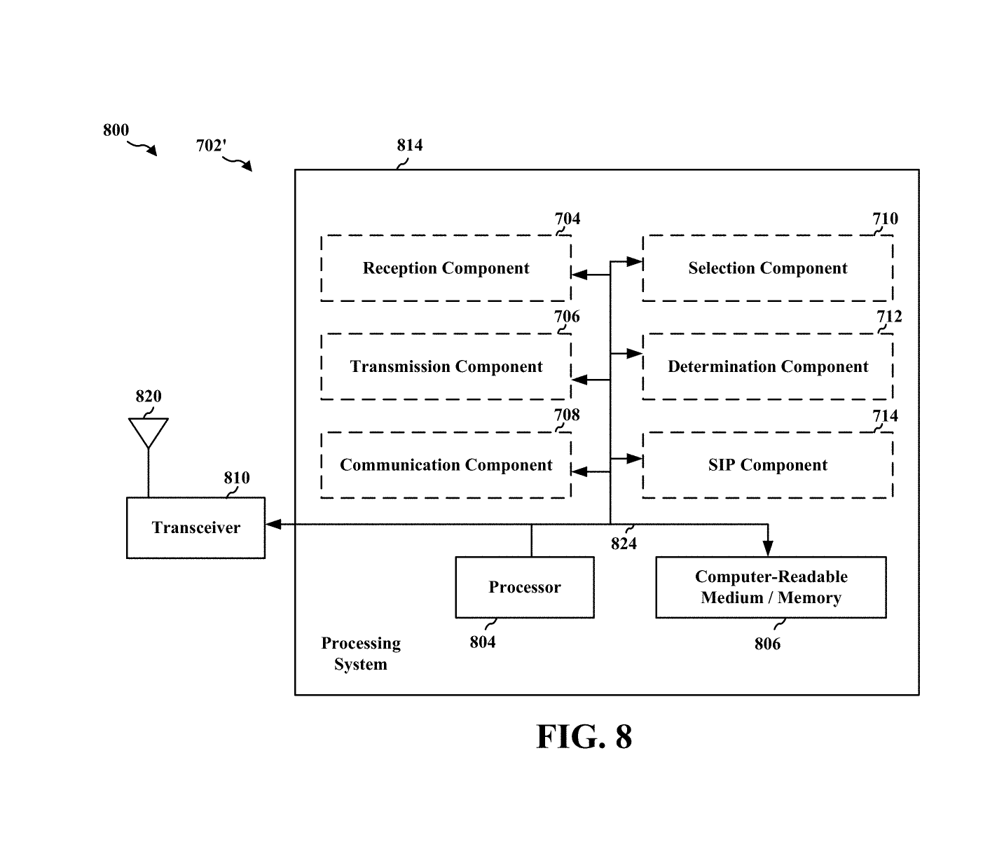

FIGS. 6A and 6B illustrate a method 600 of wireless communication. The method 600 may be implemented by a first UE, such as the first UE 404a of FIG. 4 and/or the first UE 504a of FIG. 5. The method 600 may be implemented by an apparatus, such as the apparatus 702/702′ of FIGS. 8 and 9. According to various aspects, one or more of the illustrated operations may be omitted, transposed, and/or contemporaneous. In an aspect, additional operations may be implemented.

At operation 602, the first UE may attempt to move a network connection in a handover from a first network node to a second network node by determining whether a QoS grant is unreceived before expiration of a first timer. The network connection may be associated with the first UE and a second UE (e.g., a network connection for a VOLTE/VT communication). For example, the first UE may perform handover from the first network node to the second network node. The first UE may begin a first timer to allow a network to grant the dedicated bearer(s) for the network connection. The first UE may attempt, during a first duration of the first timer, to detect a QoS grant associated with the network connection in association with the handover.

In the context of FIG. 4, the first UE 404a may attempt to move the network connection 420 in a handover 410 from the first network node 402a to the second network node 402b by determining whether a QoS grant 430 is unreceived before expiration of a first timer.

In the context of FIG. 5, the first UE 504a may attempt to move a network connection with the second UE 504b in a handover from a first network node to a second network node (operation 520) by determining whether a QoS grant is unreceived from the network 560 before expiration of a first timer (operation 522).

At operation 604, the first UE may transmit a first SIP re-invite message based on the determination that the QoS grant is unreceived before expiration of the first timer. For example, the first UE may determine that the first timer has expired and the first UE failed to detect a QoS grant during the first duration of the first timer. The first UE may generate a first SIP re-invite message, which may include codec information associated with the network connection, and transmit the first SIP re-invite message to allow the network time to allocate dedicated bearer(s) for the network connection (e.g., session refresh).

In the context of FIG. 4, the first UE 404a may transmit the first SIP re-invite message 422 based on the determination that the QoS grant 430 is unreceived before expiration of the first timer.

In the context of FIG. 5, the first UE 504a may transmit the first SIP re-invite message based on the determination that the QoS grant is unreceived before expiration of the first timer (operation 524).

At operation 606, the first UE may determine that the QoS grant is unreceived before expiration of a second timer. For example, the first UE may begin a second timer in order to allow the network to allocate dedicated bearer(s) and transmit a QoS grant to the first UE. The first UE may attempt to detect the QoS grant during a second duration of the second timer. If the first UE fails to detect the QoS grant during the second duration of the second timer, the first UE may determine that the QoS grant is unreceived before expiration of the second timer.

In the context of FIG. 4, the first UE 404a may determine that the QoS grant 430 is unreceived before expiration of a second timer.

In the context of FIG. 5, the first UE 504a may determine that the QoS grant is unreceived before expiration of a second timer (operation 526).

At operation 608, the first UE may transmit a second SIP re-invite message to the second UE based on the determination that the QoS grant is unreceived before expiration of the second timer. For example, the first UE may generate a second SIP re-invite message and transmit the second SIP re-invite message to the second UE to prevent a timeout (e.g., RTP/RTCP timeout) at the second UE. In an aspect, the first UE may include, in the second SIP re-invite message, at least one SDP parameter indicating that the first UE is in an inactive mode (e.g., video m-line may indicate inactive). In aspects in which the second timer has a second duration shorter than a first duration of the first timer and/or in which the second timer expires before the first timer expires, the first UE may send the second SIP re-invite message before the first timer expires, before the first UE sends the first SIP re-invite message at operation 604, before both the first timer expires and the first UE sends the first SIP re-invite message at operation 604, and/or at any other suitable time.

In the context of FIG. 4, the first UE 404a may transmit, to the second UE 404b, the second SIP re-invite message 424 in order to prevent a timeout at the second UE 404b.

In the context of FIG. 5, the first UE 504a may transmit, to the second UE 504b, the second SIP re-invite message in order to prevent a timeout at the second UE 504b (operation 528).

At operation 610, the first UE may transmit, to the second UE, a SIP message indicating that the first UE is requesting the QoS grant associated with the network connection. For example, the first UE may generate a SIP message, which may be a SIP INFO message. The first UE may include, in the SIP message, an indication of a timer duration for which the second UE is to wait before ending the network connection. The timer duration may be associated with a third timer of the first UE, such as a T3480 timer. The third timer duration may prevent the second UE from indefinitely waiting for packets over the network connection from the first UE (e.g., if the first UE goes out of service, if the first UE fails to send out a BYE message after the third timer expires).

In the context of FIG. 4, the first UE 404a may transmit, to the second UE 404b, the SIP message 426 to indicate to the second UE 404b that the first UE 404a is requesting the QoS grant 430.

In the context of FIG. 5, the first UE 504a may transmit, to the second UE 504b, the SIP INFO message to indicate to the second UE 504b that the first UE 504a is requesting the QoS grant (operation 530).

At operation 612, the first UE may transmit a resource allocation request. The first UE may transmit the resource allocation request after the transmission of the SIP message. For example, the first UE may generate a resource allocation request and transmit the resource allocation request to an MME, for example, after expiration of the first timer. In an aspect, the first UE may start the third timer in association with the transmission of the resource allocation request.

In the context of FIG. 4, the first UE 404a may transmit, to the MME 462, the resource allocation request 428. The first UE 404a may begin the third timer in association with the transmission of the resource allocation request 428.

In the context of FIG. 5, the first UE 504a may transmit, to the network 560, the resource allocation request in order to elicit the QoS grant (operation 532).

At operation 614, the first UE may maintain the network connection via a default bearer until the QoS grant is received. The first UE may maintain the network connection via the default bearer until the network connection is ended (e.g., a user of the first UE ends a call). For example, the first UE may maintain the network connection via the default bearer by identifying the default bearer and transmitting one or more packets associated with the network connection over the identified default bearer. In an aspect, the first UE may maintain the network connection via the default bearer based on the determination that the QoS grant is unreceived before expiration of the first timer. In another aspect, the first UE may maintain the network connection via the default bearer based on the determination that the QoS response is unreceived before expiration of the third timer.

In the context of FIG. 4, the first UE 404a may maintain the network connection 420 via the default bearer 442 until the QoS grant 430 is received (or until the network connection is ended).

In the context of FIG. 5, the first UE 504a may maintain the network connection via the default bearer until the QoS grant is received (or until the network connection is ended) (operation 534).

At operation 616, the UE may determine that the QoS grant is unreceived before expiration of the third timer. For example, the UE may attempt to detect the QoS grant during the duration of the third timer and, if the QoS grant is unreceived at expiration of the third timer, the UE may determine that the QoS grant is unreceived before expiration of the third timer. In aspects, the third timer may be a T3480 timer.

In the context of FIG. 4, the first UE 404a may determine that the QoS grant 430 is unreceived before expiration of the third timer.

In the context of FIG. 5, the first UE 504a may determine that the QoS grant is unreceived before expiration of the third timer (operation 536).

At operation 618, the UE may retransmit the resource allocation request based on the determination that the QoS grant is unreceived before expiration of the third timer. For example, the UE may generate another message that includes the resource allocation request (see, e.g., operation 612) so that the resource allocation request may be retransmitted, and the UE may retransmit the resource allocation to an MIME.

In the context of FIG. 4, the first UE 404a may retransmit the resource allocation request 428 based on the determination that the QoS grant 430 is unreceived before expiration of the third timer. For example, the first UE 404a may retransmit the resource allocation request 428 to the MME 462.

In the context of FIG. 5, the first UE 504a may retransmit the resource allocation request to the network 560, which may include an MME. (operation 538).

At operation 620, the UE may restart the third timer. For example, the UE may determine that the resource allocation request is retransmitted, and the UE may begin the third timer again. The restarted third timer may be a T3480 timer.

In the context of FIG. 4, the first UE 404a may restart the third timer based on retransmission of the resource allocation request 428.

In the context of FIG. 5, the first UE 504a may restart the third timer based on retransmission of the resource allocation request (operation 538).

At operation 622, the UE may determine that the QoS grant is unreceived after a predetermined number of retransmissions of the resource allocation request. For example, the UE may determine that the QoS grant is unreceived before expiration of the restarted third timer. The UE may determine a number of retransmissions of the resource allocation request and compare that number to a threshold (e.g., four). In one aspect, the UE may determine a number of times that third timer has expired without reception of the resource allocation request and compare that number to another threshold (e.g., five). If the number of retransmissions of the resource allocation request does not meet or exceed the threshold (and/or if the number of expirations of the third timer does not meet or exceed the other threshold), then the UE may return to operation 616 for subsequent retransmissions of the resource allocation request. However, if the number of retransmissions of the resource allocation request does meet or exceed the threshold (and/or if the number of expirations of the third timer does meet or exceed the other threshold), then the UE may refrain from retransmitting the resource allocation request, may release a PTI allocated for the bearer resource allocation request procedure, and may proceed to operation 624.

In the context of FIG. 4, the first UE 404a may determine that the QoS grant 430 is unreceived after a predetermined number of retransmissions of the resource allocation request 428. If the number of retransmissions of the resource allocation request 428 does not meet or exceed the threshold (and/or if the number of expirations of the third timer does not meet or exceed the other threshold), then the first UE 404a may retransmit the resource allocation request 428. However, if the number of retransmissions of the resource allocation request 428 does meet or exceed the threshold (and/or if the number of expirations of the third timer does meet or exceed the other threshold), then the first UE 404a may refrain from retransmitting the resource allocation request 428 and may release a PTI allocated for the bearer resource allocation request procedure.

In the context of FIG. 5, the first UE 504a may determine that the QoS grant is unreceived after a predetermined number of retransmissions of the resource allocation request (operation 540). If the number of retransmissions of the resource allocation request does not meet or exceed the threshold (and/or if the number of expirations of the third timer does not meet or exceed the other threshold), then the first UE 504a may retransmit the resource allocation request (operation 538). However, if the number of retransmissions of the resource allocation request does meet or exceed the threshold (and/or if the number of expirations of the third timer does meet or exceed the other threshold), then the first UE 504a may refrain from retransmitting the resource allocation request and may release a PTI allocated for the bearer resource allocation request procedure.

At operation 624, the first UE may restart the first timer to wait for the QoS grant. For example, the first UE may determine that the QoS grant is unreceived after one or more retransmission of the resource allocation request, and the UE may being the first timer again. In an aspect, the first UE may maintain the network connection via the default bearer. Based on restarting the first timer, the method 600 may return to operation 604, for example, so that the UE may transmit a SIP re-invite message to a second UE based on a determination that the QoS grant is unreceived before expiration of the restarted first timer. The UE may then perform one of more of the illustrated operations of the method 600 in order to wait for and/or elicit a QoS grant.

In the context of FIG. 4, the first UE 404a may restart the first timer to wait for the QoS grant 430.

In the context of FIG. 5, the first UE 504a may determine that the QoS grant remains unreceived and the first UE 504a may restart the first timer (operation 542). The first UE 504a may then determine if the QoS grant is unreceived before expiration of the restarted first timer (operation 522).

At operation 626, the UE may receive the QoS grant. For example, the UE may detect the QoS grant during one or more durations of one or more timers. When the UE receives the QoS grant, the UE may refrain from performing one or more of the illustrated operations of the method 600. That is, the UE may receive the QoS grant at any time and, therefore, the UE may refrain from performing one or more operations designed to wait for or elicit a QoS grant.

In the context of FIG. 4, the first UE 404a may receive the QoS grant 430. For example, the first UE 404a may receive the QoS grant 430 from the MME 462.

In the context of FIG. 5, the first UE 504a may receive the QoS grant (operation 544). For example, the first UE 504a may receive the QoS grant from the network 560.

At operation 628, the UE may maintain the network connection based on the received QoS grant associated with the network connection. For example, the UE may identify bearer allocation information and/or resource allocation information indicated by the QoS grant, and the UE may transmit data (e.g., packets) over dedicated bearer(s) allocated by the QoS grant and/or on resources allocated by the QoS grant.

In the context of FIG. 4, the first UE 404a may maintain the network connection based on the QoS grant 430 associated with the network connection 420. For example, the first UE 404a may transmit data (e.g., packets) over the dedicated bearer(s) 440, which may be allocated by the QoS grant 430.

In the context of FIG. 5, the first UE 504a may maintain the network connection based on the QoS grant associated with the network connection (operation 546). For example, the first UE 504a may transmit data (e.g., packets) over dedicated bearer(s) 440 allocated by the QoS grant.

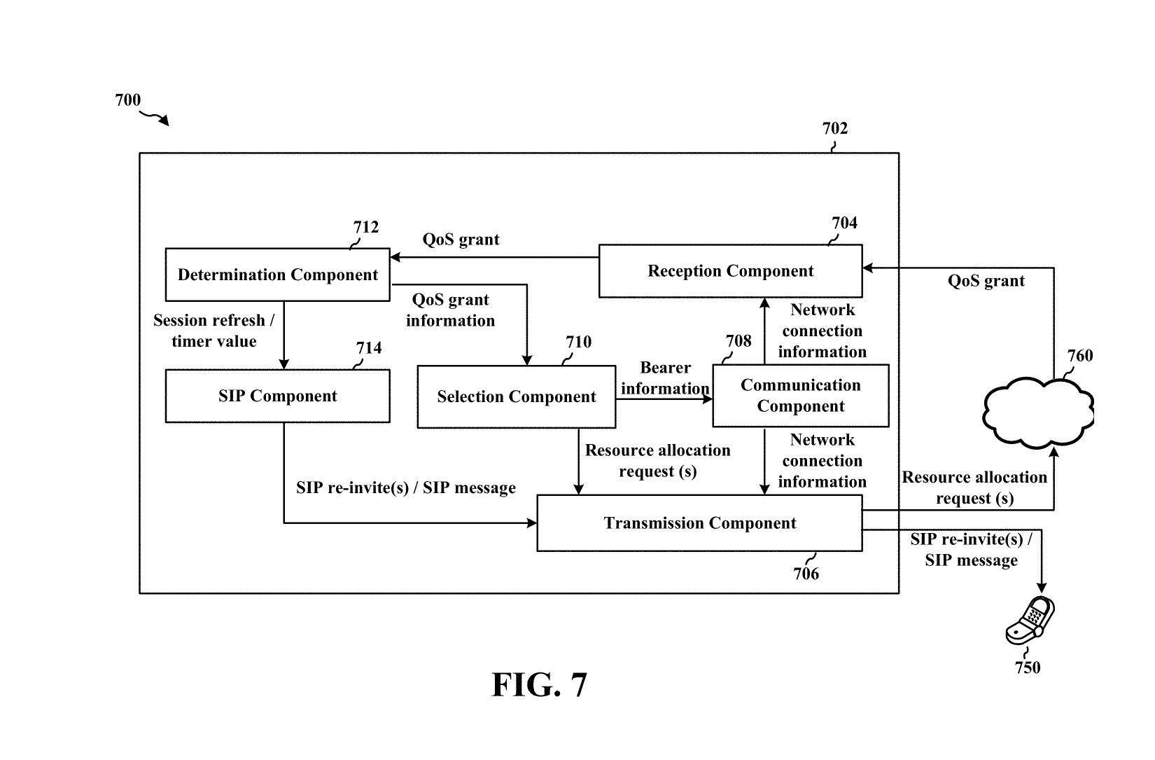

FIG. 7 is a conceptual data flow diagram 700 illustrating the data flow between different means/components in an exemplary apparatus 702. The apparatus 702 may be a UE (e.g., the UE 104, the first UE 404a, the first UE 504a). The apparatus 702 may include additional/other components and/or may include additional/other data flow.

The apparatus 702 may include a reception component 704 configured to receive signals, for example, from another UE 750 and/or from a network 760 (e.g., from an MME).

The apparatus 702 may include a transmission component 706 configured to transmit signals, for example, to the UE 750 and/or to the network 760 (e.g., to the MME).

The apparatus 702 may include a communication component 708. The communication component 708 may attempt to move a network connection in a handover from a first network node to a second network node. The network connection may be associated with the UE 750. The communication component 708 may require a QoS grant, for example, in order to determine dedicated bearer(s) associated with the network connection when the communication component 708 attempts to move the network connection in the handover.

The apparatus 702 may include a determination component 712. The determination component 712 may be configured to determine whether a QoS grant associated with the network connection is unreceived before expiration of a first timer. For example, the determination component 712 may be configured to begin a first timer in association with the attempt to move the network connection in the handover. If the QoS grant is unreceived before expiration of the first timer, the determination component 712 may provide an indication of a session refresh to a SIP component 714.

The SIP component 714 may be configured to generate a first SIP re-invite message based on the determination that the QoS grant is unreceived before expiration of the first timer. The SIP component 714 may generate the first SIP re-invite message to include codec information negotiated for the network connection with the UE 750. The SIP component 714 may cause the transmission component 706 to transmit the first SIP re-invite message in order to allow the network 760 to grant the dedicated bearer(s) and transmit the QoS grant (e.g., session refresh).

The determination component 712 may further be configured to determine that the QoS grant is unreceived before expiration of a second timer. In aspects, the second timer may have a duration less than a duration of the first timer. The determination component 712 may be configured to indicate to the SIP component 714 that another SIP re-invite should be transmitted in order to avoid timeout (e.g., RTP/RTCP timeout) at the UE 750.

The SIP component 714 may be configured to generate a second SIP re-invite message. The SIP component 714 may generate the second SIP re-invite message to include at least one SDP parameter that indicates that the apparatus 702 is in an inactive mode, for example, in order to avoid timeout at the UE 750. In an aspect, the SIP component 714 may generate the second SIP re-invite message to include a video m-line that indicates inactive, for example, when the network connection with the UE 750 includes a video call (e.g., VT).

In an aspect, the SIP component 714 may further be configured to generate a SIP message that indicates the apparatus 702 is requesting the QoS grant associated with the network connection. In an aspect, the SIP message may be a SIP INFO message. In an aspect, the determination component 712 may provide a timer duration associated with a third timer (e.g., a T3480 timer) to the SIP component 714, and the SIP component 714 may include the timer duration associated with the third timer in the generated SIP message, for example, in order to indicate a time for which the UE 750 is to wait before termination of the network connection. The SIP component 714 may cause the transmission component 706 to transmit the SIP message to the UE 750.

The apparatus 702 may include a selection component 710. The determination component 712 may indicate to the selection component 710 that a QoS grant is unreceived for the network connection. The selection component 710 may be configured to select a bearer and/or resources to provide to the communication component 708 for the network connection. When the QoS grant information is absent, the selection component 710 may be configured to maintain the network connection via a default bearer, for example, until the QoS grant is received. The selection component 710 may provide default bearer information to the communication component 708 so that data (e.g., packets) associated with the network connection may be transmitted over the default bearer.

In aspects, the selection component 710 may be configured to generate a resource allocation request, for example, to elicit the QoS grant from the network 760. The selection component 710 may cause the transmission component 706 to transmit the resource allocation request. The determination component 712 may begin a third timer in association with transmission of the resource allocation request.

The determination component 712 may be configured to determine that the QoS grant is unreceived before expiration of the third timer. The determination component 712 may indicate, to the selection component 710, that the QoS grant remains unreceived. The selection component 710 may then cause the transmission component 706 to retransmit the resource allocation request. The determination component 712 may restart the third timer in association with retransmission of the resource allocation request.

The selection component 710 may be configured to determine that the QoS grant is unreceived after a predetermined number of retransmission of the resource allocation request (e.g., four (4) retransmissions). When the selection component 710 determines that the QoS grant is unreceived after the predetermined number of retransmissions of the resource allocation request, the selection component 710 may refrain from additional retransmissions of the resource allocation request. The determination component 712 may be configured to restart the first timer based on the determination, by the selection component 710, that the QoS grant is unreceived after the predetermined number of retransmissions of the resource allocation request.

The network 760 may allocate the dedicated bearer(s) for the network connection and transmit the QoS grant indicating the dedicated bearer(s) to the apparatus 702. The determination component 712 may receive, through the reception component 704, the QoS grant and may determine that the QoS grant is received. The determination component 712 may provide the QoS grant to the selection component 710. The selection component 710 may identify, based on the QoS grant, the allocated dedicated bearer(s) and/or resources associated with the network connection. The selection component 710 may provide the allocated dedicated bearer(s) and/or resources to the communication component 708. The communication component 708 may then communicate data associated with the network connection (e.g., packets) over the dedicated bearer(s) and/or on the allocated resources.

The apparatus may include additional components that perform each of the blocks of the algorithm in the aforementioned flowcharts of FIGS. 5, 6A, and 6B. As such, each block in the aforementioned flowcharts of FIGS. 5, 6A, and 6B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, 714 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 706, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712, 714. The components may be software components running in the processor 804, resident/stored in the computer readable medium/memory 806, one or more hardware components coupled to the processor 804, or some combination thereof. The processing system 814 may be a component of the UE 350 and may include the memory 360 and/or at least one of the TX processor 368, the RX processor 356, and the controller/processor 359.

In one configuration, the apparatus 702/702′ for wireless communication includes means for attempting to move a network connection in a handover from a first network node to a second network node by determining whether a QoS grant associated with the network connection is unreceived before expiration of a first timer, the network connection associated with the apparatus and a second UE. The apparatus 702/702′ may include means for transmitting a first SIP re-invite message based on the determination that the QoS grant is unreceived before the expiration of the first timer.

In an aspect, the apparatus 702/702′ may include means for determining that the QoS grant is unreceived before expiration of a second timer, the second timer having a second duration less than a first duration of the first timer. The apparatus 702/702′ may include means for transmitting a second SIP re-invite message to the second UE based on the determination that the QoS grant is unreceived before the expiration of the second timer, and the second SIP re-invite message may include at least one SDP parameter indicating that the apparatus is in an inactive mode to avoid a timeout associated with the second UE.

In an aspect, the apparatus 702/702′ may include means for transmitting a SIP message to the second UE, the SIP message indicating that the apparatus is requesting the QoS grant associated with the network connection. The apparatus 702/702′ may include means for transmitting a resource allocation request after the transmission of the SIP message. In an aspect, the SIP message is a SIP INFO message. In an aspect, the SIP message further comprises a third duration, associated with a third timer, for which the second UE is to wait before termination of the network connection associated with the apparatus and the second UE.

In an aspect, the apparatus 702/702′ may include means for determining that the QoS grant is unreceived before expiration of the third timer. The apparatus 702/702′ may include means for retransmitting the resource allocation request based on the determination that the QoS grant is unreceived after the expiration of the third timer. The apparatus 702/702′ may include means for restarting the third timer.

In an aspect, the apparatus 702/702′ may include means for determining that the QoS grant is unreceived after a predetermined number of retransmissions of the resource allocation request. The apparatus 702/702′ may include means for restarting the first timer to wait for the QoS grant associated with the network connection. In an aspect, the predetermined number of retransmissions is four (4), and the resource allocation request is not retransmitted after a fifth expiration of the third timer.

In an aspect, the apparatus 702/702′ may include means for maintaining the network connection via a default bearer until the QoS grant associated with the network connection is received by the apparatus.

In an aspect, the apparatus 702/702′ may include means for receiving the QoS grant associated with the network connection. The apparatus 702/702′ may include means for maintaining the network connection based on the received QoS grant associated with the network connection.

The aforementioned means may be one or more of the aforementioned components of the apparatus 702 and/or the processing system 814 of the apparatus 702′ configured to perform the functions recited by the aforementioned means. As described supra, the processing system 814 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a first user equipment (UE), the method comprising:
attempting, by the first UE, to move a network connection in a handover from a first network node to a second network node by determining whether a quality of service (QoS) grant associated with the network connection is unreceived before expiration of a first timer, the network connection associated with the first UE and a second UE; and
transmitting, by the first UE, a first session initiation protocol (SIP) re-invite message based on the determination that the QoS grant is unreceived before the expiration of the first timer.

2. The method of claim 1, further comprising:
determining, by the first UE, that the QoS grant is unreceived before expiration of a second timer, the second timer having a second duration less than a first duration of the first timer; and
transmitting, by the first UE, a second SIP re-invite message to the second UE based on the determination that the QoS grant is unreceived before the expiration of the second timer,
wherein the second SIP re-invite message comprises at least one session description protocol (SDP) parameter indicating that the first UE is in an inactive mode to avoid a timeout associated with the second UE.

3. The method of claim 2, further comprising:
transmitting, by the first UE, a SIP message to the second UE, the SIP message indicating that the first UE is requesting the QoS grant associated with the network connection; and
transmitting, by the first UE, a resource allocation request after the transmission of the SIP message.

4. The method of claim 3, wherein the SIP message is a SIP INFO message.

5. The method of claim 3, wherein the SIP message further comprises a third duration, associated with a third timer, for which the second UE is to wait before termination of the network connection associated with the first UE and the second UE.

6. The method of claim 5, further comprising:
determining, by the first UE, that the QoS grant is unreceived before expiration of the third timer;
retransmitting, by the first UE, the resource allocation request based on the determination that the QoS grant is unreceived after the expiration of the third timer; and
restarting, by the first UE, the third timer.

7. The method of claim 6, further comprising:
determining, by the first UE, that the QoS grant is unreceived after a predetermined number of retransmissions of the resource allocation request; and
restarting, by the first UE, the first timer to wait for the QoS grant associated with the network connection.

8. The method of claim 7, wherein the predetermined number of retransmissions is four (4), and the resource allocation request is not retransmitted after a fifth expiration of the third timer.

9. The method of claim 1, further comprising:
maintaining, by the first UE, the network connection via a default bearer until the QoS grant associated with the network connection is received by the first UE.

10. The method of claim 1, further comprising:
receiving, by the first UE, the QoS grant associated with the network connection; and
maintaining, by the first UE, the network connection based on the received QoS grant associated with the network connection.

11. The method of claim 1, wherein the second UE comprises a terminating device for the network connection.

12. The method of claim 1, wherein the first network node comprises one of a first eNB or a first wireless local area network (WLAN) access point (AP), and the second network node comprises one of a second eNB or a second WLAN AP.

13. A apparatus for wireless communication associated with a first user equipment (UE), the apparatus comprising:
means for attempting to move a network connection in a handover from a first network node to a second network node by determining whether a quality of service (QoS) grant associated with the network connection is unreceived before expiration of a first timer, the network connection associated with the apparatus and a second UE; and
means for transmitting a first session initiation protocol (SIP) re-invite message based on the determination that the QoS grant is unreceived before the expiration of the first timer.

14. The apparatus of claim 13, further comprising:
means for determining that the QoS grant is unreceived before expiration of a second timer, the second timer having a second duration less than a first duration of the first timer; and
means for transmitting a second SIP re-invite message to the second UE based on the determination that the QoS grant is unreceived before the expiration of the second timer,
wherein the second SIP re-invite message comprises at least one session description protocol (SDP) parameter indicating that the apparatus is in an inactive mode to avoid a timeout associated with the second UE.

15. The apparatus of claim 14, further comprising:
means for transmitting a SIP message to the second UE, the SIP message indicating that the apparatus is requesting the QoS grant associated with the network connection; and
means for transmitting a resource allocation request after the transmission of the SIP message.

16. The apparatus of claim 15, wherein the SIP message is a SIP INFO message.

17. The apparatus of claim 15, wherein the SIP message further comprises a third duration, associated with a third timer, for which the second UE is to wait before termination of the network connection associated with the apparatus and the second UE.

18. The apparatus of claim 17, further comprising:
means for determining that the QoS grant is unreceived before expiration of the third timer;
means for retransmitting the resource allocation request based on the determination that the QoS grant is unreceived after the expiration of the third timer; and
means for restarting the third timer.

19. The apparatus of claim 18, further comprising:
means for determining that the QoS grant is unreceived after a predetermined number of retransmissions of the resource allocation request; and
means for restarting the first timer to wait for the QoS grant associated with the network connection.

20. The apparatus of claim 19, wherein the predetermined number of retransmissions is four (4), and the resource allocation request is not retransmitted after a fifth expiration of the third timer.

21. The apparatus of claim 13, further comprising:
means for maintaining the network connection via a default bearer until the QoS grant associated with the network connection is received by the apparatus.

22. The apparatus of claim 13, further comprising:
means for receiving the QoS grant associated with the network connection; and
means for maintaining the network connection based on the received QoS grant associated with the network connection.

23. An apparatus for wireless communication associated with a first user equipment, the apparatus comprising:
a memory; and
at least one processor coupled to the memory and configured to:
attempt to move a network connection in a handover from a first network node to a second network node by determining whether a quality of service (QoS) grant associated with the network connection is unreceived before expiration of a first timer, the network connection associated with the apparatus and a second UE; and
transmit a first session initiation protocol (SIP) re-invite message based on the determination that the QoS grant is unreceived before the expiration of the first timer.

24. The apparatus of claim 23, wherein the at least one processor is further configured to:
determine that the QoS grant is unreceived before expiration of a second timer, the second timer having a second duration less than a first duration of the first timer; and
transmit a second SIP re-invite message to the second UE based on the determination that the QoS grant is unreceived before the expiration of the second timer,
wherein the second SIP re-invite message comprises at least one session description protocol (SDP) parameter indicating that the apparatus is in an inactive mode to avoid a timeout associated with the second UE.

25. The apparatus of claim 24, wherein the at least one processor is further configured to:
transmit a SIP message to the second UE, the SIP message indicating that the apparatus is requesting the QoS grant associated with the network connection; and
transmit a resource allocation request after the transmission of the SIP message.

26. The apparatus of claim 25, wherein the SIP message further comprises a third duration, associated with a third timer, for which the second UE is to wait before termination of the network connection associated with the apparatus and the second UE.

27. The apparatus of claim 26, wherein the at least one processor is further configured to:
determine that the QoS grant is unreceived before expiration of the third timer;
retransmit the resource allocation request based on the determination that the QoS grant is unreceived after the expiration of the third timer; and
restart the third timer.

28. The apparatus of claim 23, wherein the at least one processor is further configured to:
maintain the network connection via a default bearer until the QoS grant associated with the network connection is received by the apparatus.

29. The apparatus of claim 23, wherein the at least one processor is further configured to:
receive the QoS grant associated with the network connection; and
maintain the network connection based on the received QoS grant associated with the network connection.

30. A computer-readable medium storing computer-executable code for wireless communication by a first user equipment (UE), comprising code to:
attempt to move a network connection in a handover from a first network node to a second network node by determining whether a quality of service (QoS) grant associated with the network connection is unreceived before expiration of a first timer, the network connection associated with the apparatus and a second UE; and
transmit a first session initiation protocol (SIP) re-invite message based on the determination that the QoS grant is unreceived before the expiration of the first timer.
